(19) United States
(12) Patent Application Publication
(10) Pub. No.: US 2008/0244854 A1
(43) Pub. Date: Oct. 9, 2008

(54) APPARATUS FOR APPLYING LIQUID

(75) Inventor: Anthony MIGNANO, Parkland, FL (US)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Master Artist Faux Painting Corporation, Deerfield Beach, FL (US)

(21) Appl. No.: 11/697,096

(22) Filed: Apr. 5, 2007

(51) Int. Cl. B05C 17/02

(52) U.S. Cl. 15/230.11; 29/895

(57) ABSTRACT

An apparatus for applying a liquid to a surface in a pattern includes a rollable core with first and second sections adjacent to each other and each having a length and a circumference. A first liquid applicator includes a material for holding and applying a liquid to a surface and is attached to the first section of the core. A second liquid applicator includes a material for holding and applying a liquid to a surface and is attached to the second section of the core. The first liquid applicator material and/or the second liquid applicator material covers a portion of its respective section's circumference that is less than the entire circumference of the section, and the first and second liquid applicators are arranged on the core so as to produce a consecutively repeating non-random pattern when the first and second liquid applicators are placed in contact with and rolled along a surface.

### BACKGROUND OF THE INVENTION

1. Field of the Invention

This invention relates in general to applying liquids to surfaces and more particularly, to a patterned paint roller.

2. Description of the Related Art

Virtually every building, inside and out, has paint or other pigmented material applied to its walls. The paint not only protects the surfaces to which it is applied, but also provides a great aesthetic benefit. Many tools currently exist which aid in the application of the paint. For instance, paint brushes, paint rollers, and paint sprayers are devices traditionally used for such applications.

FIG. 1 shows a paint roller 100. Paint rollers 100 are well-known in the art and are generally made of a tubular sleeve or core 102 wrapped with a paint-absorbing material 104, sometimes wool or other fur, but often synthetic, such as synthetic fur or foam. The material is selected for its ability to temporarily hold an amount of paint and transfer the paint to a wall or other surface. The core 102 of the roller 100 is slid onto the receiver 106 of a roller handle 108, which is rotatably attached to the roller handle 108 so that the roller 100 can spin in relation to the handle 108. When the roller material 104 is dipped in paint and rolled against a wall 200, as shown in FIG. 2, the spinning roller material 104 provides continuous contact with the wall 200, thereby producing a smooth, even application 202 of paint.

In situations where textures, effects, or more than just a single color of paint is desired, painters have turned to paint applicators with special configurations, textures, sizes and/or shapes. One example is a paint roller made from a sponge material. The holes in the sponge produce paint voids when the sponge makes contact with a surface, thereby producing a non-uniform application of paint. Another example is a roller that has what appears to be a rag twisted laterally along its length. The twisted rag provides high spots that contact the wall and apply paint, low spots that do not touch the wall, and some areas that barely make contact with the wall and produce light areas of paint application.

When a pattern, such as a checkerboard or other repeating pattern is desired, painters are currently presented with the tedious options of masking areas by, for example, taping off squares, blocking areas with shapes, making multiple passes while alternating an area between the passes, or others. Each of these methods takes time, is tedious, and can easily result in error, run-over, bleeding, bleed-through, inconsistencies, and many other problems. Currently, no single paint tool allows a repeating pattern to be easily and quickly applied.

Accordingly, a need exists to overcome the problems with the prior art as discussed above.

### SUMMARY OF THE INVENTION

Embodiments of the present invention include an apparatus for applying a liquid to a surface in a pattern, with the apparatus including a rollable core with first and second sections adjacent to each other and each having a length and a circumference. The apparatus also includes a first and second liquid applicator, where the first liquid applicator includes a material for holding and applying a liquid to a surface, the first liquid applicator attached to the first section of the core, and the second liquid applicator, which is different from the first liquid applicator, includes a material for holding and applying a liquid to a surface, the second liquid applicator being attached to the second section of the core. In addition, at least one of the first liquid applicator material and the second liquid applicator material covers a portion of its respective section's circumference that is less than the entire circumference of the section, and the first and second liquid applicators are arranged on the core so as to produce a consecutively repeating non-random pattern when the first and second liquid applicators are placed in contact with and rolled along a surface.

In accordance with a further feature, the present invention includes a third section on the core and a third liquid applicator including a material for holding and applying a liquid to a surface, the third liquid applicator attached to the third section of the core adjacent to the second liquid applicator, the third liquid applicator material covering a portion of the third section's circumference that is less than the entire circumference, wherein the first, second, and third liquid applicators are arranged on the core so as to produce a consecutively repeating non-random pattern when placed in contact with and rolled along a surface.

In accordance with yet another feature, the first liquid applicator and the third liquid applicator sandwich the second liquid applicator and are attached to the core in a substantially same orientation relative to each other circumferentially around the core.

In still another embodiment, the present invention includes a method for applying a liquid to a surface in a pattern, the method including the steps of placing a patterned roller against a surface, where the patterned roller has a rollable core with first and second sections adjacent to each other and each having a length and a circumference, a first liquid applicator including a material for holding and applying a liquid to a surface, the first liquid applicator attached to the first section of the core, and a second liquid applicator, being different from the first liquid applicator, and including a material for holding and applying a liquid to a surface, the second liquid applicator attached to the second section of the core. In addition, at least one of the first liquid applicator material and the second liquid applicator material covers a portion of its respective section's circumference that is less than the entire circumference of the section, and the first and second liquid applicators are arranged on the core so as to produce a consecutively repeating non-random pattern when the first and second liquid applicators are placed in contact with and rolled along a surface. The method further includes the step of moving the patterned roller along the surface of the wall so as to cause the core to rotate along the surface.

In accordance with a further feature of the present invention, the patterned roller includes a third section on the core and a third liquid applicator including a material for holding and applying a liquid to a surface, the third liquid applicator attached to the third section of the core adjacent to the second liquid applicator, the third liquid applicator material covering a portion of the third section's circumference that is less than the entire circumference, wherein the first, second, and third liquid applicators are arranged on the core so as to produce a consecutively repeating non-random pattern when the applicators are placed in contact with and rolled along a surface.

In accordance with yet another feature, the present invention includes removing at least one of the liquid applicators from the core and attaching at least a third liquid applicator to the core, the at least a third liquid applicator having at least one of a material, a texture, and a shape that is different from at least one of the removed at least one liquid applicators.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating a prior art paint roller being attached to a prior art paint roller handle.

FIG. 2 is an illustration of the prior art paint roller and handle of FIG. 1 being used to apply paint to a wall to produce a uniform area of paint application.

FIG. 3. is a side view of a paint roller in accordance with an embodiment of the present invention.

FIG. 4. is an edge view of the paint roller of FIG. 3 in accordance with an embodiment of the present invention.

FIG. 5 is an illustration of the paint roller of FIGS. 3 and 4 attached to a paint roller handle and being used to apply paint to a wall to produce a repeating, non-random pattern of paint, according to an embodiment of the present invention.

FIG. 6 is an illustration of a paint roller with triangular applicator patterns according to an embodiment of the present invention.

FIG. 7 is an illustration of a paint roller with circular applicator patterns according to an embodiment of the present invention.

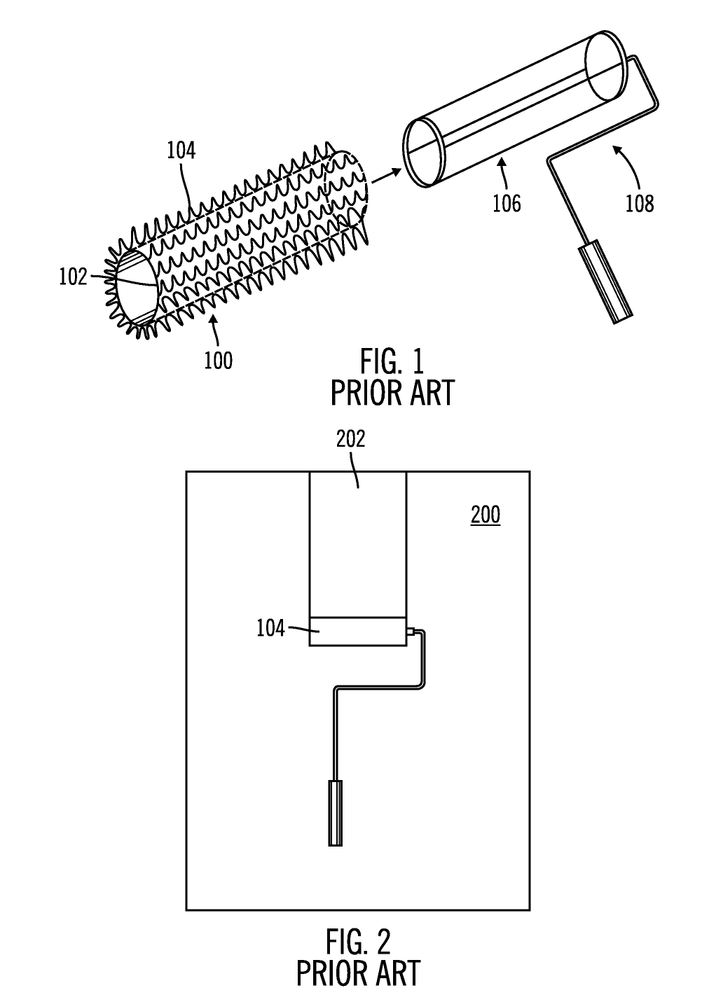

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Embodiments of the present invention provide a roller for paint or application of other types of liquids that greatly saves time and produces superior results over currently-known devices and methods for painting surfaces. The present invention is capable of producing a repeating pattern that would have previously taken a significant amount of time and effort to produce. In one embodiment, the roller resembles a traditional paint roller with areas of material removed so that when the roller is pressed against a surface and rolled along the surface, areas of paint application interspersed with areas of no paint application, create a non-random repeating pattern on the surface to which the roller is applied. The invention is provided in many variations of shapes, shape relations, materials, and textures, so as to provide a single tool that will provide an almost unlimited number of design possibilities.

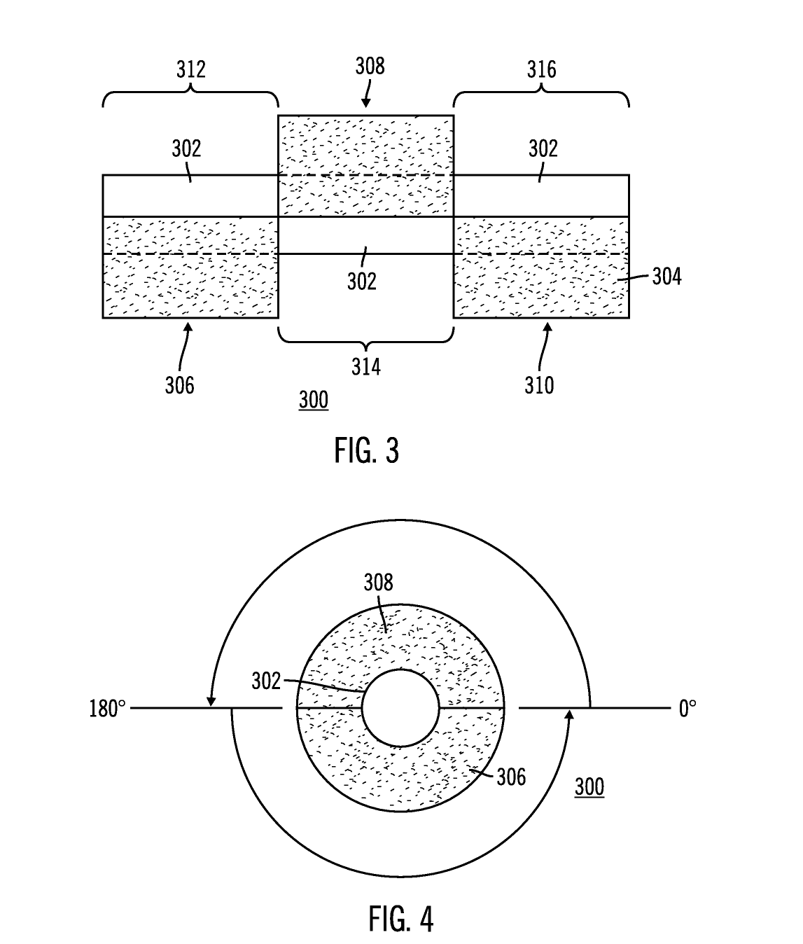

FIG. 3 shows a first embodiment of the present invention. The inventive paint roller 300 includes a core 302. The core 302 can have a round tubular shape, as is used in traditional paint rollers, or can have other shapes that can provide ease in use or additional paint patterns. In the embodiment shown in FIG. 3, the roller can be thought of as having three sections 312, 314, and 316. Each section 312, 314, and 316 can have attached to it a material 304. Each section can have the same material or one or more of the sections can have a different material.

The material used is generally selected from a group of materials, such as foam, natural fiber, synthetic fibers, fur, and others, that are well suited for holding liquids, such as paint, and transferring that liquid to a surface. Therefore, the material 304 attached to one of the sections 312, 314, and 316 becomes a liquid applicator 306, 308, and 310, respectively, which is used to apply the paint to a surface as will be described below. Many materials are currently used for commercially-available paint rollers and can also be used with embodiments of the present invention. The present invention, however, is not limited to any specific material or material type. In accordance with embodiments of the present invention, the material 304 of one or more of the sections 312, 314, and 316 only covers a portion of the core 302.

FIG. 3 is a side view of the core 302 where it can be seen that the first and third applicators 306 and 310, respectively, sandwich the second liquid applicator 308. As is shown better in FIG. 4, the first and third applicators 306 and 310 cover only a bottom portion of the core 302, while the second applicator 308 covers only an upper portion of the core 302. Of course, as the roller 300 rotates, references to “upper” and “lower” portions of the core 302 become meaningless. In this particular embodiment, the first and second applicators 306 and 310 are substantially the same size and attached to the core in substantially the same orientation circumferentially around the core.

FIG. 4 shows an edge view of the roller 300 shown in FIG. 3. The core 302 viewed from the edge looks like a circle. However, as stated above, the core 302 does not, necessarily, have to be circular in shape. In this particular embodiment of the invention, the material 304 of the second applicator 308, shown in the upper portion of the drawing, covers the circumference of the core 302 from 0 degrees to 180 degrees, or 50% of the core's outer surface. The first 306 and second 310 (not shown) liquid applicators are attached to the core's outer surface from 180 degrees to 360 degrees, or 50% of the core's outer surface. The three liquid applicators 306, 308, and 310, therefore, each cover an alternating half of the core outer surface and, in this particular embodiment, have zero overlap with the immediately adjacent section.

The edge view of FIG. 4 makes it clear that when the roller 300 is placed against a surface, there will always be a material portion of the roller that will be in direct contact with the surface. The roller 300 therefore, will roll smoothly. However, a distinctive pattern will appear on the wall's surface due to the alternating areas of material and no material as the roller rotates. The pattern will exactly repeat as long as the roller is rotated along the wall's surface and as long as the applicators are holding sufficient paint.

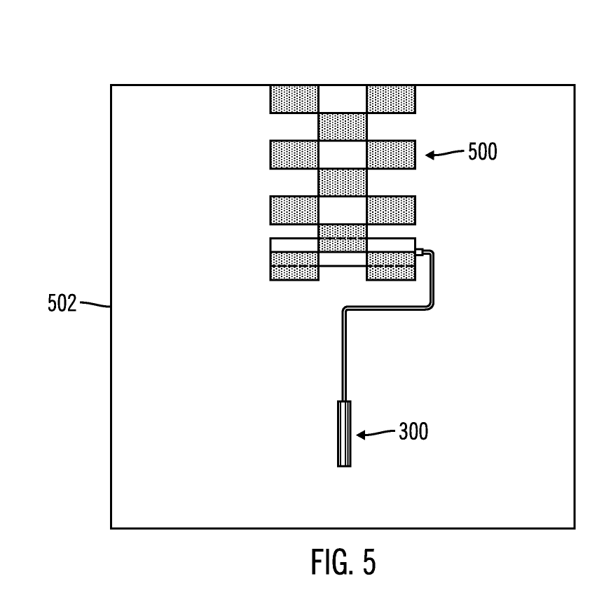

FIG. 5 shows an example of a paint pattern 500 produced by placing the embodiment of the paint roller shown in FIGS. 3 and 4 against a wall 502 and rolling the roller 300 along the wall's surface. As can be clearly seen in FIG. 5, the first, second, and third liquid applicators 306, 308, and 310 are arranged on the core 302 so as to produce a repeating pattern when applied to a surface 502. The pattern 500 differs from those patterns of previously known rollers or paint tools, such as sponges or rags, because the pattern 500 of the roller 300 is uniform and non-random. Although one or more of the applicators of the roller may be made of a sponge, rag, or other material that does itself apply random patterns, the overall pattern of the multiple applicators contacting the wall sequentially as the roller is rotated along the surface of a wall is non-random.

Applying a pattern, such as pattern 500, by simply rolling a paint roller over a wall greatly reduces the amount of time that painting such a pattern previously required. That is to say, no masking step is necessary. The inventive roller can then be rolled over the pattern 500 shown in FIG. 5 at various angles, to produce a more complicated pattern.

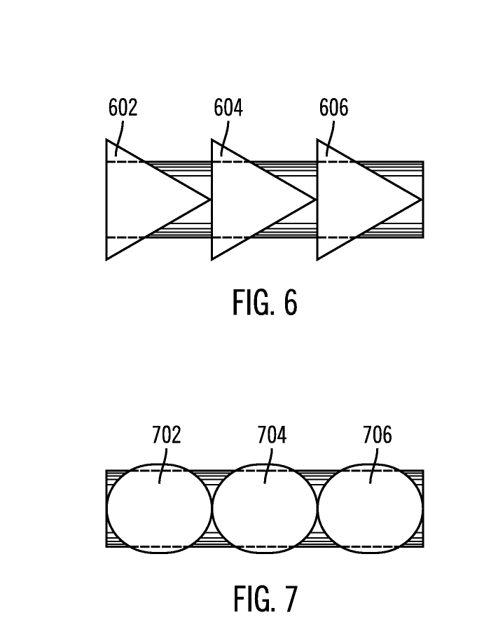

The invention, it should be noted, is not limited to the shapes shown in FIG. 3. As an example, the first, second, and third liquid applicators 306, 308, and 310 can be shapes as shown in FIGS. 6 and 7. In FIG. 6, a first, second, and third liquid applicator, 602, 604, and 606, respectively, have triangular shapes. In a third example, shown in FIG. 7, a first, second, and third liquid applicator, 702, 704, and 706, respectively, have circular shapes. These are just a few examples and the use of many other shapes and sizes are envisioned with embodiments of the present invention.

In one embodiment of the present invention, the applicators are separate pieces that each individually attach to the core. The attachment can be accomplished by sliding the applicators over the core so that they are frictionally held in place or they can be attached via an attachment mechanism, such as hooks and loops (know by the trade name Velcro), screws, snaps, magnets, channels, or any other securing mechanism. This seperable applicator embodiment provides the advantage that different sizes and shapes of liquid applicators can be interchangeably used on a single core. In addition, the applicators can be made available in varying materials and textures. This feature, combined with the ability to individually attach each applicator to the core, allows extraordinary flexibility to the painter in selecting and creating patterns and texture variations. For example, in a single pattern, a rectangle, a circle, and a diamond can all be applied by locating a diamond-shaped applicator next to a rectangular-shaped applicator, which may be next to a circular-shaped applicator.

Further pattern flexibility can be gained by the ability to control or adjust the amount of offset each applicator has from its adjacent applicators. For instance, the first, second, and third liquid applicators 306, 308, and 310 shown in FIG. 3 have 100% offset from the next adjacent applicator. In contrast, the first, second, and third liquid applicators 602, 604, and 606 shown in FIG. 6 have zero offset. The shapes can be varied from zero to 100% offset to produce creative paint patterns.

It is envisioned that the liquid applicators are each slidably positionable on the outer surface of the core 302. Therefore, when a user is finished with a particular roller, a new set of applicators-either as a single piece or a plurality of separate pieces-can be placed on the core.

The inventive paint roller can be manufactured by removing sections of material from a paint roller so as to create at least two adjacent sections in the roller with each section having at least one void of material that spans the section and is offset from a void of material of an adjacent section on the paint roller. The offset can be any amount. The remaining material is arranged so as to produce a consecutively repeating non-random pattern when placed in contact with and rolled along a surface. The removal of the material can be by any means that will leave areas that will not make contact with a surface as well as other areas. In this context, the term “void” does not necessarily mean that there is no material at all. The material that makes up the roller can simply be shortened, smashed, or the like.

A paint roller has just been described that reduces time, effort, and produces superior results to current methods and tools for applying paint to surfaces. Embodiments of the present invention apply a repeating non-random pattern to a surface by simply placing the inventive roller against the surface and causing the roller to roll down the surface, thereby causing the applicators to alternatively make contact with the surface and transfer paint or other liquid to the surface.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. An apparatus for applying a liquid to a surface in a pattern, the apparatus comprising:
a rollable core with first and second sections adjacent to each other and each having a length and a circumference;
a first liquid applicator including a material for holding and applying a liquid to a surface, the first liquid applicator attached to the first section of the core; and
a second liquid applicator, being different from the first liquid applicator, and including a material for holding and applying a liquid to a surface, the second liquid applicator attached to the second section of the core,
wherein at least one of the first liquid applicator material and the second liquid applicator material covers a portion of its respective section's circumference that is less than the entire circumference of the section, and the first and second liquid applicators are arranged on the core so as to produce a consecutively repeating non-random pattern when the first and second liquid applicators are placed in contact with and rolled along a surface.

2. The apparatus according to claim 1, further comprising:
a third section on the core; and
a third liquid applicator including a material for holding and applying a liquid to a surface, the third liquid applicator attached to the third section of the core adjacent to the second liquid applicator, the third liquid applicator material covering a portion of the third section's circumference that is less than the entire circumference, wherein the first, second, and third liquid applicators are arranged on the core so as to produce a consecutively repeating non-random pattern when placed in contact with and rolled along a surface.

3. The apparatus according to claim 2, wherein the first liquid applicator and the third liquid applicator sandwich the second liquid applicator and are attached to the core in a substantially same orientation relative to each other circumferentially around the core.

4. The apparatus according to claim 1, wherein the liquid applicators are removably attached to the core.

5. The apparatus according to claim 4, wherein the liquid applicators are removably attached by at least one of:
snaps;
screws;
books and loops;
channels; and
magnets.

6. The apparatus according to claim 4, wherein the first and second liquid applicators are each slidably positionable on an outer surface of the core.

7. The apparatus according to claim 6, wherein the first and second liquid applicators are each separate and movably independent from each other so as to be independently attachable to the core.

8. The apparatus according to claim 1, wherein the first and second liquid applicators are located adjacent to each other and each cover an alternating half of the core's outer surface.

9. The apparatus according to claim 1, wherein each of the first and second liquid applicators on the core is in at least intermittent direct physical contact with the other one of the first and second liquid applicators.

10. The apparatus according to claim 1, wherein the material of the first and second liquid applicators is one of:
a foam;
a natural fiber;
a synthetic fiber; and
a fur.

11. The apparatus according to claim 1, wherein the repeating non-random pattern is at least one of:
squares;
rectangles;
triangles; and
diamonds.

12. A method for applying a liquid to a surface in a pattern, the method comprising:
placing a patterned roller against a surface, where the patterned roller includes:
a rollable core with first and second sections adjacent to each other and each having a length and a circumference;
a first liquid applicator including a material for holding and applying a liquid to a surface, the first liquid applicator attached to the first section of the core; and
a second liquid applicator, being different from the first liquid applicator, and including a material for holding and applying a liquid to a surface, the second liquid applicator attached to the second section of the core,
wherein at least one of the first liquid applicator material and the second liquid applicator material covers a portion of its respective section's circumference that is less than the entire circumference of the section, and the first and second liquid applicators are arranged on the core so as to produce a consecutively repeating non-random pattern when the first and second liquid applicators are placed in contact with and rolled along a surface; and moving the patterned roller along the surface of the wall so as to cause the core to rotate along the surface.

13. The method according to claim 12, wherein the patterned roller further includes:
a third section on the core; and
a third liquid applicator including a material for holding and applying a liquid to a surface, the third liquid applicator attached to the third section of the core adjacent to the second liquid applicator, the third liquid applicator material covering a portion of the third section's circumference that is less than the entire circumference, wherein the first, second, and third liquid applicators are arranged on the core so as to produce a consecutively repeating non-random pattern when the applicators are placed in contact with and rolled along a surface.

14. The method according to claim 12, further comprising:
removing at least one of the liquid applicators from the core, and
attaching at least a third liquid applicator to the core, the at least a third liquid applicator having at least one of a material, a texture, and a shape that is different from at least one of the removed at least one liquid applicators.

15. A method for manufacturing a patterned roller, the method comprising:
removing sections of material from a paint roller so as to create at least two adjacent sections in the roller with each section having at least one void of material that spans the section and is offset from a void of material of an adjacent section on the paint roller, wherein the remaining material is arranged so as to produce a consecutively repeating non-random pattern when placed in contact with and rolled along a surface.
